(19) United States
(12) Patent Application Publication
(10) Pub. No.: US 2024/0372385 A1
(43) Pub. Date: Nov. 7, 2024

(54) CONNECTING ARRANGEMENT, CHARGING SOCKET AND SYSTEM OF A CONNECTING ARRANGEMENT AND A CHARGING SOCKET

(71) Applicant: Auto-Kabel Management GmbH, Hausen i.W. (DE)

(72) Inventors: Matthias Weinbrich, Dorsten (DE); Gordon Kraft, Viersen (DE)

(21) Appl. No.: 18/689,778

(22) PCT Filed: Aug. 16, 2022
(86) PCT No.: PCT/EP2022/072828

§ 371 Date: Mar. 6, 2024

(30) Foreign Application Priority Data
Sep. 10, 2021 (DE) 10 2021 123 488.3

(51) Int. Cl. H02J 7/00; B60L 53/16; H01R 4/34; H01R 13/52

(52) U.S. Cl. CPC H02J 7/0042; B60L 53/16; H01R 4/34; H01R 13/5202

(57) ABSTRACT

The invention relates to a connecting arrangement, a charging socket and to a system of a charging socket and a connecting arrangement, which are distinguished by in each case a high thermal conductivity and thermal capacity and allow a reliable assembly. In particular, this is made possible by the use of a busbar with a tapering connecting bolt with through hole.

The object relates to a connecting arrangement, in particular for electric vehicles, a charging socket, and a system of the charging socket and the connecting arrangement.

One of the challenges of large-scale electrification of automobility lies in minimizing the charging times of the energy stores involved. The tank of a conventional vehicle with internal combustion engine is filled with fuel within a few minutes, which contains sufficient energy for hundreds of kilometers of driving distance. By contrast, in electrically operated vehicles, an electrical accumulator with high capacity must usually be charged. In order to charge the battery as quickly as possible, preferably significantly faster than it is discharged subsequently during driving operation, high charging powers are used with high currents and/or voltages.

In order to convey the required high charging powers, for example, starting from a charging station to the vehicle accumulator, the entire transmission path of the charging station socket from the charging station socket, via the vehicle-side charging socket, as far as the battery must offer very good electrical conduction. In particular, all transitions between the individual components of the transmission path have to have particularly low transition resistances.

A further challenge relates to a reliable assembly of the power-conducting components. In particular, charging lines must be securely connected. These are operated with increasingly high electrical voltages of several hundred volts. Contact with these components during assembly and/or maintenance can be life-threatening.

In particular, after assembly, all electrical contacts, in particular those which lead to high electrical powers, must also be covered and preferably sealed. On the one hand, this protects the users and technicians. Furthermore, the service life of the components can be increased by protection against environmental influences.

The object of the invention was thus, inter alia, to provide a particularly well-conducting connecting arrangement and a charging socket which provide increased safety both during assembly and during operation and which enable a long-term stable connection between the charging socket and the connecting arrangement.

The object is achieved by a connecting arrangement according to claim 1, a charging socket according to claim 39, and a system according to claim 41.

The present connecting arrangement comprises a housing.

The housing of the connecting arrangement can be formed from a non-conductive material. For example, the housing can be formed from a plastics material, in particular from a high-temperature plastics material, for example PA6GF15, UL94, or another plastics material which is suitable for high temperatures. It is also possible for the housing to be made of a ceramic, glass, a metal material, which is coated, for example, with an insulation layer, or other materials.

The housing can in particular be formed from a combination of a plurality of materials. For example, a housing made of a mechanically loadable, first material, such as a metal material, is conceivable. This can take up mechanical loads, for example. In addition, a further material can be provided, for example a non-conductive material such as plastics material, ceramic, and/or glass. A combination of two materials can ensure mechanical stability on the one hand and good electrical insulation of the housing on the other hand. It is also possible to use at least partially thermally highly conductive materials. For example, a housing formed at least partially from a metal material can provide a high thermal capacity and a high thermal conductivity to the surrounding environment. Conductive parts of the housing, in particular metal parts, are insulated from live components, for example by means of insulating coatings and/or other non-conducting components.

The present connecting arrangement comprises at least two busbars. In the following, one of the busbars is first described.

In particular, the busbar has a substantially rectangular cross section. The cross section can have two mutually opposite and substantially parallel wide sides and two narrow sides arranged substantially perpendicular thereto, substantially in parallel with one another and opposite one another. At least one of the narrow sides is in particular perpendicular to at least one of the wide sides. The busbar has at least partially a longitudinal axis. This runs substantially perpendicular to both the narrow sides and the wide sides. The wide side is wider perpendicular to the longitudinal axis than the narrow side. A width extent can be defined as the axis which runs perpendicular to the longitudinal axis and in parallel with the wide side.

If the busbar is cut to length, an end face can also be defined. For example, the longitudinal axis can at least partially substantially form the surface normal to this.

The busbar is formed from an electrically conductive material, for example from a metal material. The busbar can be formed from copper, aluminum, alloys thereof, and/or from further metal materials. In particular, the busbar can be formed from soft-annealed aluminum.

Aluminum is lightweight, which is of great advantage for use in vehicles. In addition, aluminum is more favorable compared to copper. The busbar can also be formed from a different material, in particular another metal material such as copper.

The busbar can be at least partially coated, for example with silver, gold, nickel and/or alloys thereof and/or multi-layer arrangements of these and/or combinations of these metal materials, for example with silver coating having a nickel sublayer.

The use of a busbar has the advantage that it provides good conductivity for heat and electrical current due to its solid design with large cross sections. Furthermore, the thermal capacity is high, especially due to the volume of the busbar. As a result of the increase surfaced in comparison with round conductors, with the same cross-sectional area, more heat can also be radiated over the surface of the busbar.

At least one of the busbars can have a cross section of at least 50 mm², preferably between 100 and 300 mm². Larger cross sections are also possible if a particularly high electrical power and/or a particularly large amount of heat has to be transported.

At least one of the busbars can have a side recess. This side recess can be located on one side of the busbar, so that the side recess interrupts the otherwise largely straight course of the longitudinal edge.

The longitudinal edge is in particular the edge between a wide side of the busbar and an adjacent narrow side of the busbar.

The side recess can have a constant shape along the surface normal to one of the wide sides of the busbar.

In a plan view of the wide side, at least on one side of the side recess substantially perpendicular to the longitudinal edge, the edge of the side recess can run from the longitudinal edge into the busbar. Both sides of the side recess can also run substantially perpendicular to the longitudinal edge into the busbar. Other edge courses of at least one side of the side recess are also possible. The side recess can thus have one or two edges which are inclined in relation to the narrow side when viewed from above. For example, at least one of the edges of the side recess can extend at an angle of 30-60° relative to the narrow side. In particular, one edge can run substantially perpendicular and the other can run obliquely to the longitudinal edge. The side recess can be shaped such that it forms a hook and/or an undercut when viewed from above onto the wide side.

The side recess can be substantially angular, for example quadrangular. The side recess can also be rounded, for example it can be substantially semi-circular. A shape of the side recess as a quarter circle is also possible.

A side recess can serve to lock the busbar in a holder provided for this purpose. A latching element of the connecting arrangement can thus engage in the side recess. A differently movable element, for example a screw element, can also engage in the side recess. Alternatively or additionally, the busbar can be overmolded by a retaining element, for example by plastics material, in particular from at least parts of the housing. This retaining element can engage in the side recess.

The connecting arrangement can comprise at least one retaining means for at least one of the busbars. In particular, the connecting arrangement can engage in the side recess of the busbar, in particular by means of the retaining means. For example, a latching element, for example a latching lug, can engage in the side recess. The retaining means can in particular enter into a form fit with the busbar, in particular the side recess of the busbar. The retaining means can in particular be elastically mounted relative to the housing and can in particular spring into the side recess. The busbar can thus latch with the retaining means, in particular in a form fit.

The retaining means can be formed as a resilient element which can latch resiliently behind a recess in the busbar, in particular in a side recess. The retaining means can be pivotable substantially transversely to the longitudinal axis of the busbar, in particular elastically deformable radially outward, so that the retaining means can bend radially outward when the busbar is pushed in, the busbar can slide past the retaining means, and the retaining means can then spring back behind a recess in the busbar, in particular into a side recess. The retaining means is thus not destroyed during the assembly of the busbar.

With suitable aids, a non-destructive unlocking of the retaining means and/or the busbar from the retaining means can also be possible. This can be necessary, for example, in the event of damage/service or the like in order to replace the housing and/or the busbar. For this purpose, it is proposed that the retaining means has an expansion receptacle for an expansion tool. The expansion receptacle can be reached, for example, through the assembly opening. The expansion receptacle can also be arranged laterally on the housing transversely to the longitudinal axis of the busbar. An expansion force acting radially outward can be exerted on the retaining means using the expansion tool. As a result, the retaining means can be removed from the side recess of the busbar, and the busbar can be removed from the housing counter to the direction of insertion.

The retaining means can also be substantially rigid. For example, the retaining means can be formed as a rigid raised portion within the housing, which is suitably shaped to engage in the side recess of the busbar. The cross section of the retaining means in the direction of the surface normal to the wide side of the busbar can be at least partially cross-sectionally adapted here to the side recess and/or the cross section of the side recess. For example, the busbar can be pushed onto the retaining means in the direction of the surface normal on at least one of the wide sides of the busbar, in particular so that the retaining means engages at least partially in the side recess. The retaining means can extend in the direction of the surface to the wide side of the busbar over at least a portion of the height of the housing interior. In particular, a distance between the housing inner wall and the retaining means can be provided in this direction on the side of the assembly opening of the housing. In this way, the busbar can be pushed in the longitudinal axis in a region of the housing near the assembly opening by the distance without being impeded by the retaining means. After the insertion, the busbar can be pushed onto the retaining means in the direction of the surface normal to at least one of the wide sides of the busbar and/or in the plug-in direction of the at least one connecting bolt, so that it engages in the side recess of the busbar. The busbar can be held by the retaining means and thus prevented from slipping out of the connecting arrangement along the longitudinal axis. In order to remove the busbar from the retaining means, it is sufficient to pull it out of the retaining means in the direction of the surface normal to the wide side of the busbar, in particular in the direction of the assembly opening.

In all these cases, the side recess of the busbar helps to improve the hold relative to its direct surroundings. In particular, in this way, the position of the busbar and in particular contact elements arranged on it, for example connecting bolts, can be clearly determined by latching in a position defined by the retaining means within the housing and/or relative to another busbar already before contacting the contact elements with elements provided therefor, in particular in a recess of a charging socket. In this way, the assembly of the connecting arrangement is decisively simplified.

In one embodiment, at least one of the busbars has a side recess on the side facing away from the other busbar, in particular on the narrow side facing away from the other busbar.

The at least two busbars are guided into the housing. Here, an end portion can be defined for each of the busbars. This is the part of the busbar which is located within the housing. In particular, the end portion can be arranged within the convex envelope of the housing. The end portion here can be the end of a busbar cut to length. The end portion of the busbar cut to length comprises the end face of the busbar. The end portion can also be a central region of a busbar which is located in the housing.

The at least two busbars are fixed in the housing. The busbars are fixed relative to one another, in particular at a distance from one another. The busbars are also fixed relative to the housing.

The housing can fix the busbars directly or indirectly. The busbars can be held substantially rigidly by the housing. A change in the position of one of the busbars relative to another busbar and/or relative to the housing is thus possible only with a deformation of the housing. An at least partially elastic fixing of the busbars through the housing is also possible. A partially elastic fixing can allow a movement of the busbar along a spatial direction, for example along the longitudinal direction of the busbar. An elastic fixing can also allow the busbar to be tilted about an axis, for example about the longitudinal axis of the busbar.

In particular in the case of long busbars which lead into the connecting arrangement, large lever forces can act on the housing. For this reason, mechanically loadable, in particular crack-resistant housing materials for the connecting arrangement are desirable. At least one of the busbars can also be formed in the housing by a housing part of a mechanically loadable material, for example from a metal material, in particular from an insulated metal material.

The connecting arrangement comprises at least two busbars.

A connecting bolt is arranged in each of the at least two busbars. The connecting bolt has a joining region extending starting from a first end face to a central region and a contact region extending starting from a second end face to the central region.

In particular, the connecting bolt can be arranged in an opening of the busbar. In particular, the opening of the busbar extends from a first wide side to the second wide side of the busbar opposite the first wide side.

The opening can, for example, be formed as a through hole. The through hole can have a substantially round cross section. An elliptical, angular, in particular triangular, quadrangular, pentagonal, hexagonal, polygonal, jagged or otherwise shaped cross section of the through hole is also possible. The through hole can have a substantially constant cross section along the thickness of the busbar or also a variable cross section. For example, the through hole can taper from a first to a second wide side.

At least one of the at least two connecting bolts is made of an electrically conductive material. In particular, the connecting bolt can be formed from a metal material, in particular copper, E-copper, aluminum, alloys thereof, and/or other metal materials. An at least partial or even complete coating of the connecting bolt is also possible; the connecting bolt can thus be coated with silver, gold, nickel and/or alloys and/or combinations thereof. In particular, the connecting bolt can be formed from copper, in particular E-copper, and can be provided at least partially, in particular substantially completely, with a silver coating having a nickel sublayer.

At least one of the at least two connecting bolts can be arranged centrally on the wide side of the busbar in relation to the central axis of the wide side of the busbar. In the case of a plan view of the wide side, the central axis can run centrally in the wide side along the longitudinal direction of the busbar, so that it has the substantially same distance on both narrow sides. The connecting bolt can also be arranged on the busbar in a decentralized and/or eccentrically in relation to the central axis of the busbar. At least the joining region of the connecting bolt can lie within the wide side of the busbar in a plan view of the wide side of the busbar. It is preferably surrounded peripherally by the inner lateral surface of the opening in the busbar and/or contacts it at least partially. The contact region of the connecting bolt can protrude beyond the wide side of the busbar in a plan view of the wide side. In an advantageous embodiment, the connecting bolt, in particular the contact region, is also located completely within the wide side in the plan view of the wide side.

The position of the at least two connecting bolts of the at least two busbars relative to one another can be selected in a targeted manner. In particular, the position thereof can be defined for at least two busbars fixed in the housing of the connecting arrangement. For example, the at least two connecting bolts of the at least two busbars can be arranged along the longitudinal axis of at least one of the busbars substantially at the same position. For example, the connecting bolts can each have substantially the same distance from the end face of the busbar to which they are in each case connected. The connecting bolts can also be offset from one another, in particular spaced apart, along the longitudinal axis. For example, one of the connecting bolts can lie closer to the end face of the busbar to which it is connected than another connecting bolt.

The two busbars can lie substantially in one plane. One of the busbars in the direction of the surface normal can also be offset from the wide side of at least one of the busbars relative to the at least one other busbar.

The at least two connecting bolts of the at least two busbars can protrude substantially equally far from the corresponding busbar to which they are connected. The connecting bolts can also protrude differently far from the corresponding busbar to which they are connected. For example, the contact regions of the connecting bolts can be substantially the same. The contact region of one of the at least two connecting bolts can also be longer than the contact region of another one of the at least two connecting bolts.

If at least one of the busbars has a side recess, the connecting bolt and the side recess of at least one busbar can be offset relative to one another along the longitudinal axis of the busbar. If the connecting bolt is arranged in an end region of the busbar, the corresponding connecting bolt can be arranged, for example, closer to the end face of the busbar than the side recess. The connecting bolt can also be spaced further apart from the end face of the busbar along the longitudinal axis of the busbar than the side recess. A spacing of the connecting bolt and the side recess from one another along the longitudinal axis increases the mechanical stability of the busbar, since the narrowings of the busbar by opening and side recess are not directly adjacent to one another. The busbar can also heat up greatly in particular in the direct vicinity of the connecting bolt, so that a particularly large amount of thermal capacity is used there. For the reason, a spacing of the side recess from the connecting bolt is advantageous. The retaining means, which can engage in the side recess, can also be protected from heat by a spacing from the connecting bolt.

The side recess and the connecting bolt of at least one of the busbars can also be substantially at the same height along the longitudinal axis of the busbar.

The lateral surface of the connecting bolt, in particular of the joining region of at least one of the at least two connecting bolts, can be substantially cylindrical.

The lateral surface of the connecting bolt and/or of the at least two connecting bolts, in particular the joining region of at least one of the and/or of the at least two connecting bolts, can be connected at least partially integrally bonded to an inner lateral surface of the opening of the busbar. This connection can be achieved in particular during welding, in particular during friction welding, in particular during rotary friction welding.

The lateral surface of the connecting bolt, in particular of the contact region of at least one of the at least two connecting bolts, can taper, in particular such that the cross section decreases with increasing distance from the busbar. In particular, the lateral surface of the connecting bolt, in particular of the contact region, can be conical.

The connecting bolt can be integrally bonded to the busbar. Other types of connection are possible, for example a frictionally engaged and/or form-fitting connection. However, an integrally bonded connection is advantageous for the electrical and thermal conductivity between the connecting bolt and the busbar.

The connecting bolt extends at an angle to the longitudinal axis of the busbar in an extension direction. In particular, the connecting bolt can extend substantially perpendicular to the longitudinal axis of the busbar and/or substantially in parallel with the surface normal to one of the wide sides of the busbar. The connecting bolt can also extend obliquely to the surface normal to one of the wide sides of the busbar, for example with a minimum angle between surface normals to one of the wide sides of the busbar and extension direction of the connecting bolt of 0-45°.

At least one of the connecting bolts can have a through hole. The at least two connecting bolts can also each have a through hole. The through hole can extend along the extension direction of the connecting bolt. In the connected state between the connecting bolt and the busbar, the through hole can extend substantially in parallel with the surface normal to the wide side of the busbar.

The through hole of at least one of the at least two connecting bolts can substantially have a round cross section. The through hole of the connecting bolt can also at least partially have a substantially oval, angular, in particular triangular, quadrangular, pentagonal, or polygonal, a star-shaped or other cross section deviating from a round shape. A cross section deviating from a round shape enables, for example, a friction welding tool to transmit a torque to the connecting bolt.

The through hole can have a substantially constant cross section along the extension direction of the connecting bolt. The through hole can also vary in its cross section along the extension direction.

In one embodiment, the connecting bolt can in particular be divided into two regions. One joining region is connected to the busbar, in particular integrally bonded in the opening of the busbar. For example, the connecting bolt can be welded to the busbar, in particular by means of a friction welding process, in particular by means of rotary friction welding.

In one embodiment, a contact region of the connecting bolt points away from the busbar, in particular in the extension direction of the connecting bolt, in particular in the plug-in direction of the connecting bolt.

The plug-in direction of the connecting bolt can be aligned in parallel with the extension direction of the connecting bolt and can point starting from the busbar to the side of the connecting bolt which protrudes further from the busbar. In particular, the plug-in direction can point from the joining region to the contact region.

The connecting bolt, in particular the contact region of the connecting bolt, can in particular be tapered, in particular with increasing distance from the busbar. In particular, an end face can be provided on the connecting bolt, in particular on the contact region of the connecting bolt, and points away from the busbar. The connecting bolt, in particular the contact region of the connecting bolt, can be tapered toward the end face. In particular, the connecting bolt can be conically tapered. The connecting bolt, in particular the contact region of the connecting bolt, can in particular be frustoconical.

The connecting bolt, in particular the joining region and/or the contact region, can at least partially have a substantially round cross section. The connecting bolt can also have a cross section deviating from a round shape. For example, the connecting bolt, in particular at least one of the regions, can at least partially have a substantially oval, angular, in particular triangular, quadrangular, pentagonal, or polygonal, a star-shaped or other cross section deviating from a round shape.

The housing of the connecting arrangement can at least partially encompass the at least two busbars. As explained above, the end portion of the corresponding busbar is arranged within the housing. The housing can have at least one receiving opening. This can be suitable for a connection part. For example, the receiving opening can serve to at least partially receive a connection part comprising at least one electrical connection element.

The connecting bolts can be located at least partially in the receiving opening. The connecting bolts can be reachable in a straight line in the extension direction of the connecting bolts through the receiving opening. The housing thus has at least partially an opening, the receiving opening, in the region which is located upstream of the connecting bolts starting from the connecting bolts in the plug-in direction thereof.

Electrical contacting of the connecting bolts is made possible by the receiving opening. For example, at least one of the connecting bolts can be electrically contacted through the receiving opening with a connection part, for example with a recess of a charging socket.

The receiving opening can have an extension and/or can comprise a volume. The receiving opening can have a peripheral lateral surface extending substantially in the extension direction of at least one of the connecting bolts. The receiving opening can thus have at least one lateral surface which extends in particular along the extension direction of the connecting bolt. The lateral surface of the receiving opening can surround at least one of the and/or the at least two connecting bolts. This can mean that the opening in the housing, which describes the receiving opening with a viewing direction in the extension direction onto the connecting bolts, in particular surrounds at least one connecting bolt and/or the at least two connecting bolts.

The housing can have further lateral surfaces. In particular, the housing can have a lateral surface extending substantially in the direction of the longitudinal axis of at least one of the busbars. In particular, the busbars can be surrounded by a lateral surface extending substantially along the longitudinal axis of at least one of the busbars.

The housing can in particular be at least partially closed in the region of the end face of at least one of the busbars, in particular by a housing wall. In particular, the busbar can contact the housing wall indirectly or directly with its end face.

The connecting bolts are arranged in the receiving opening. In particular, the connecting bolts are arranged within the receiving opening in the event of a projection of the connecting arrangement in the extension direction of at least one of the connecting bolts. Along the extension direction of the connecting bolts, at least one of the connecting bolts can be arranged at least partially within the receiving opening, in particular within the region and/or volume encompassed by the lateral surface of the receiving opening within the receiving opening. At least one of the connecting bolts thus protrudes into the receiving opening. At least one of the connecting bolts can also be arranged along its extension direction only outside the region and/or volume surrounded by the lateral surfaces. At least one of the connecting bolts can also protrude at least partially beyond the housing in the extension direction from the receiving opening, in particular can protrude beyond at least a part of the lateral surface. An arrangement of at least one connecting bolt, preferably of the at least two connecting bolts within the housing, including the receiving opening, can be conducive to a reliable assembly of the connecting arrangement, since the potentially live connecting bolts are protected from contact.

In an independently inventive embodiment, the connecting plug can have at least one separating element, in particular in the housing. The separating element is in particular made of a non-conductive material, for example of a plastics material, ceramic, glass, or another non-conductive material. The separating element can be arranged at least partially between the busbars. For example, the separating element can be formed as a part of the housing. In one embodiment, the separating element and at least a part of the remaining housing are formed in one piece, for example cast and/or sprayed. The separating element can be formed as a partition wall. The separating element can divide the interior of the housing at least partially and/or substantially completely into at least two separate sub-regions. In particular, the separating element can continuously have a distance to both busbars along each of the busbars.

A separating element can decisively extend the paths for leakage currents between the busbars and can thus largely prevent them. In the event of a complete separation of two partial regions of the interior of the housing, leakage currents between the busbars can be almost completely prevented. Arcs between the busbars and/or connecting bolts can also be prevented. The separating element thus enables the transporting of higher voltages with lower losses.

The connecting arrangement can comprise at least one seal. The seal can be arranged in the region of the receiving opening of the housing of the connecting arrangement. In particular, the seal can be arranged peripherally around the receiving opening. The seal can, for example, be attached to the end face of the lateral surface of the receiving opening. This has the advantage of a fixed pressing of the seal between the receiving opening and a region on which the receiving opening is fastened. For example, the connecting arrangement can be screwed to a region and the seal can thus be pressed between the region and the connecting arrangement.

In an independently inventive embodiment, the seal can be arranged, for example, on the inner surface of the lateral surface of the receiving opening. For example, the seal can substantially terminate flush with the edge of the receiving opening. The seal can also have a greater length extent in the extension direction of at least one of the connecting bolts than the distance between the edge of the receiving opening and the seal. An arrangement of the seal on the inner lateral surfaces has the advantage that the sealing effect depends primarily on the shape of a connection part which is inserted into the receiving opening. The seal is arranged between the inner side of the lateral surface and the connection part, preferably in a press fit. In particular, the insertion depth of the connection part into the receiving opening is in this way secondary to irrelevant for the effect of the seal, provided the contact with the seal is present. A tolerance of the insertion depth of a connection part into the receiving opening can thus be achieved without compromises having to be made in the sealing effect. In particular, for the sealed assembly of a connecting arrangement according to the invention on the connection part, it can be sufficient to fasten at least one of the connecting bolts to the connection part. The sealed connection to the connection part establishes itself automatically.

In particular, a seal, in particular on the lateral surface of the receiving opening, can enable a connection between the connecting arrangement and a charging socket, which comprises, for example, a connection part matching the receiving opening.

Some properties of the seal are described below. Further seals which are described later can also be designed in any of the ways described below.

The seal can be made of silicone, rubber, plastics material or other flexible materials. Preferably, materials are used for the seal which are temperature resistant. In one embodiment, the seal is produced together with the housing in a two-component injection molding process. This lowers the manufacturing costs and leads to a particularly durable connection between the housing and the seal. By means of the two-component injection molding, a one-piece component is created which, however, is formed from two different materials, for example in particular silicone and another plastics material, in particular PBT. The transition between the hard component and the soft component already occurs during production and the materials form an interlinked transition. The materials can adhere to one another here by adhesion.

The seal can in particular have one, two or more individual ribs and/or sealing lips. A plurality of ribs can in particular run along the full circumference of the seal. Ribs have the advantage of a better sealing effect against seals without ribs and/or with only one rib. This is relevant in particular in the case of a seal on the inner wall of the lateral surface, since a sufficient sealing effect has to be achieved there, solely by the press fit between a connection part and the lateral surface.

The seal can be shape-matched to a further seal or a connection element which, for example, is arranged on and/or comprised by a charging socket. The seal can, for example, engage in the element on the charging socket.

A seal on the housing on the connecting arrangement and/or on a connection part and/or on a charging socket can make the connection between the components that are indirectly contacted via the seal substantially gas-, liquid-, and/or pressure-tight.

The housing of the connecting arrangement can comprise a further opening. The further opening can be configured to pass busbars into the connecting arrangement, in particular into the housing of the connecting arrangement. It is therefore referred to below as a bar opening. The bar opening can in particular be cross-sectionally adapted to at least one busbar, preferably to the at least two busbars. This can mean that the cross section of the bar opening substantially corresponds to that of the busbars. The bar opening can, for example, be a single opening in the housing. It is also possible for the bar opening to comprise a plurality of partial openings. A partial opening can surround a single or a plurality of busbars in a cross-sectionally matched manner.

In addition, a housing part, in particular as part of the housing, can be provided which surrounds at least one busbar, preferably the at least two busbars. The housing part can comprise at least two openings. At least one of the openings of the housing part can surround at least one busbar, preferably can surround it in a cross-sectionally matched manner.

The housing part can be formed from a non-conductive material, in particular from plastics material, in particular high-temperature plastics material. Other materials such as ceramics, glass or the like are also possible. The housing part can be formed from the substantially same material as the housing. A housing part made of a flexible material, for example rubber, silicone, plastics material, or similar materials is also possible.

The housing part can be attachable to the housing of the connecting arrangement, in particular in a frictionally engaged and/or form-fitting manner. For example, the fastening can take place by means of retaining means, for example by means of frictionally engaging and/or form-fitting retaining means. For example, screws can be used, for which in particular holes can be provided on the housing part and/or screw receptacles on the connecting arrangement. The holes can be formed, for example, by feedthroughs formed in the housing part, for example from a metal material. The screw can, for example, be arranged in a captive manner in the hole. At least one of the screw receptacles can be formed in the housing of the connecting arrangement, for example as a blind hole or as a thread which is formed in the housing, in particular from a metal material.

A seal, called a busbar seal, can be provided on the bar opening and/or on at least one busbar. The seal can be arranged between the housing and/or the housing part and at least one of the busbars, preferably in a press fit. The seal can enclose the busbars in a substantially gas-tight, liquid-tight and/or pressure-tight manner. Alternatively or additionally, the seal can also terminate in a gas-, liquid- and/or pressure-tight manner with the housing, in particular with the edge of the bar opening into the housing and/or through the housing part. In this way, the at least two busbars can be guided in a gas-, liquid- and/or pressure-tight manner into the housing of the connecting arrangement.

The connecting arrangement can thus comprise at least one busbar seal which is arranged in particular at least partially between at least one of the busbars and the housing and/or the housing part.

A housing part seal can also be provided between the housing part and the housing. In particular, this seal can serve to seal the transition between the housing part and the housing. In particular, this seal can surround the two busbars peripherally.

The busbar seal and housing part seal can also both be formed from a one-piece seal. In this case, the housing part can be omitted. The housing part can also itself be formed as a seal which is arranged in particular between at least one of the busbars and the housing.

A housing part has, among other things, the advantage that the seals are held between the busbars and the connecting arrangement, and in particular a mechanical force can be exerted thereon, so that a better sealing effect at the transition between busbars and connecting arrangement results.

The housing part can be formed in one piece. A multi-part structure of the housing part is also possible. In particular, the housing part can comprise an upper housing part which can be placed onto at least one of the at least two busbars from a first wide side of a busbar. The housing can also comprise a lower housing part which can be placed onto a busbar or the at least two busbars from a second wide side opposite the first wide side of said busbar or said at least two busbars. The upper and the lower housing parts can engage in one another. For example, one of the two housing parts can have a raised portion which engages in a recess on the other housing part. Retaining means can also connect the two housing parts, i.e., upper and lower housing parts. For example, form-fitting and/or frictionally engaging retaining means, for example hooks, holes and/or threads for screws, for example made of a metal material, or similar retaining means can be provided. A screw can, for example, be arranged in a captive manner in a hole provided for this purpose; a multi-part embodiment of the housing part has the advantage that the housing part does not have to be pushed onto the busbars along the longitudinal axis of the busbars, but can instead be placed in position from the side. This is important in particular if the course of the busbar is not straight and even if a connecting bolt is already attached to at least one of the busbars. In this case, the housing part cannot be pushed along the longitudinal axis of the busbar, for example starting from the end face of the busbar.

The seal between the housing part and the busbars and/or between the housing part and the connecting arrangement can also be designed in multiple parts, in particular in two parts.

At least one of the busbars can in particular be electrically insulated at least partially from its surroundings. For this purpose, the busbar is, for example, coated with an insulating layer made of a non-conductive material, for example a plastics material. A lacquer or a similar electrically non-conductive coating is also possible. The insulated region of at least one of the busbars can extend from outside the housing into the housing. In particular, a part of the end portion of the at least one busbar can thus be insulated.

In particular, the insulation of the busbar can extend further into the housing than the seal, which is arranged between the busbar and the housing and/or the housing part; in this way the seal has only contact with the insulating layer of the busbar, not with the conductor material of the busbar. The insulation can also already be arranged only partially in a region in which the seal contacts the busbar, so that the busbar is partially insulated and partially stripped in the region in which the busbar contacts the seal.

For example, in the region of the connecting bolt, the busbar can be free of insulation, i.e., stripped. In this case, it is not necessary for an insulation to already be present on the busbar, which has been removed. It is also possible that the busbar has hitherto not been insulated in the stripped region.

The region of the busbar in which the connecting bolt is connected thereto can in particular be stripped. In the event that the connecting bolt is connected to the busbar at the end of a busbar which has been cut to length, the entire end region can be stripped, in particular up to the end face. A center tap in which the connecting bolt is connected to the busbar in a central region of the busbar is also possible. In this case, the busbar can be stripped in the region of the connecting bolt and surrounded by insulation on one or both sides of the connecting bolt along the longitudinal axis.

In one exemplary embodiment, the housing of the connecting arrangement can comprise an assembly opening. The assembly opening can in particular be arranged on a side of the connecting arrangement, in particular of the housing of the connecting arrangement, facing away from the receiving opening. The assembly opening can be positioned in such a way that it exposes the regions of at least one or the at least two busbars in which the connecting bolts are connected to the busbar. For example, the connecting bolts can extend through at least one of the busbars, so that the part of the connecting bolt which extends through the busbar can be reached through the assembly opening. The assembly opening exposes at least one of the connecting bolts, preferably the at least two connecting bolts. In particular, “expose” in this case means that the opening is arranged in such a way that a straight line runs through the assembly opening along the extension direction of at least one of the connecting bolts and runs through the through hole of the connecting bolt. In particular, “expose” means that the at least two connecting bolts of the at least two busbars can be reached on a straight line through the assembly opening.

An assembly opening can in particular be advantageous if at least one of the connecting bolts has a through hole. A retaining means, such as a screw, can be inserted into the through hole of the connecting bolt through the assembly opening. Tools, such as a screwdriver, hex key or a similar tool can also be guided through the assembly opening in the direction of a busbar and/or a connecting bolt and can be brought into contact therewith, for example with a screw in the connecting bolt.

The assembly opening can be formed as a single continuous opening. In another embodiment, at least two partial openings of the assembly opening are provided. In particular, a separate partial opening can be provided for each connecting bolt. A connecting bolt can be reached through a given partial opening. In particular, starting from at least one of the connecting bolts in its extension direction starting from the through hole, a straight line can be drawn through the assembly opening. For example, a tool can thus be guided toward the through hole of the connecting bolt in a straight line, in parallel with the extension direction of at least one of the connecting bolts. In particular, one or more separating elements mentioned above can achieve a separation of two or more partial openings from one another.

The assembly opening can have a peripheral lateral surface extending substantially in the extension direction of at least one of the connecting bolts. The lateral surface is at least largely formed from a non-conductive material. The lateral surface can be a part of the housing; in particular, the lateral surface and at least parts of the housing can be formed in one piece. The lateral surface can also be a component which is separate from the rest of the housing and which is in particular fastened to the housing, for example glued. The lateral surface protrudes from the housing wall surrounding it, in particular in the extension direction of at least one of the connecting bolts. The lateral surface can protrude from the housing at least partially substantially perpendicular to the housing wall surrounding it and/or in parallel with the extension direction of the connecting bolt. Alternatively or additionally, the lateral surface can protrude into the housing.

In particular, the lateral surface can surround the assembly opening peripherally. Additionally or alternatively, a separate, in particular encompassing, lateral surface can be provided for at least one or the at least two connecting bolts. A lateral surface between the two busbars and/or the accesses to the connecting bolts can also be provided. In particular, two or more partial openings of the assembly opening can each have a lateral surface. The lateral surface about a partial opening can, for example, be substantially round. Rectangular and other shapes are also possible. The lateral surface can increase the distance between the housing opening and the busbar and thus contributes to increased safety. The possible direct entry angle from the housing edge to the busbar is also reduced. A corresponding lateral surface for a busbar and/or a connecting bolt and/or a lateral surface between the busbars can prevent accidental contacting of the busbars with one another by a tool, for example by a screwdriver, made of a metal material. A lateral surface can also be arranged around one of the partial openings, while the other does not have its own lateral surface. Such an asymmetrical arrangement of lateral surfaces can enable selective securing of the connecting bolts. For example, only the positive terminal of a pair of charging lines (the busbars) can be protected in this way, while the negative pole at ground potential remains more easily reachable than the positive pole. An assembler can also be informed as to which assembly sequence must be selected.

The assembly opening can be closable. An assembly opening closure can in particular be provided for this purpose. The assembly opening closure can be configured to close the assembly opening. The assembly opening closure can be formed, for example, as a cover.

The assembly opening closure can at least largely be formed from a non-conductive material, for example from a plastics material, ceramic, or other non-conductive materials. In particular, the assembly opening closure can largely be made of the same material as at least parts of the housing.

The assembly opening closure can be formed as a cover with a flat side and a circumferential boundary arranged substantially perpendicular to the first side, for example in the form of a lateral surface. For example, the flat side of the assembly opening closure can substantially have a rectangular, rounded rectangular, round, oval or other shape.

The assembly opening closure can be arranged on the housing of the connecting plug in a captive manner. In particular, the assembly opening closure can be arranged movably on the housing. For this purpose, retaining means such as at least one or more hinges, film hinges, rails, flexible retaining means such as tabs made of flexible materials, for example plastics material tabs, or similar retaining means can be provided.

The retaining means for the assembly opening closure can be arranged below the assembly opening. This can mean that the retaining means are arranged at a distance from the assembly opening in the direction of gravity in the connected state of the connecting arrangement. It can thus be achieved that the open assembly opening closure is driven away from the assembly opening by gravity. This thus does not interfere with access to the assembly opening. Lesser requirements can also be placed on the retaining means, since they do not have to hold the assembly opening closure in a fixed position, but rather only need to hold it loosely from falling.

The assembly opening closure can be connected to the housing. In particular, fastening means can be provided in order to fasten the assembly opening closure to the housing. The assembly opening closure can, for example, be connected to the housing in a frictionally engaged and/or form-fitting manner. For example, the assembly opening closure can be fitted on the housing and held there, for example by the elasticity of the material of the assembly opening closure. For example, latching means can be provided on the assembly opening closure and/or the housing and corresponding recesses and/or protrusions, with which the latching means can engage. Screw closures, for example, are also conceivable. Holes can be provided in the assembly opening closure and allow screws to be guided through them. A screw can, for example, be arranged in a captive manner in a hole provided for this purpose. The holes can, for example, be formed as feedthroughs formed in the assembly opening closure with through hole, for example rings and/or sleeves, in particular as feedthroughs made of a metal material. In one embodiment, screws can be provided in the holes in the assembly opening closure in a captive manner. Screw receptacles into which the screws can be screwed can be provided on the housing. Screw receptacles can comprise threads which are formed in the housing. In particular, screw receptacles made of a metal material can be formed.

The fastening means can represent at least a part of the retaining means and can likewise serve to keep the assembly opening closure on the connecting arrangement in a captive manner. The retaining means can also serve, among other things, for fastening the assembly opening closure to the housing of the connecting arrangement.

At least one seal, referred to below as an assembly seal, can be arranged in the region of the assembly opening closure. For example, the assembly seal can be arranged on the assembly opening closure. The assembly seal can also be arranged on the housing in the region of the assembly opening, in particular in the region in which the assembly opening closure is arranged with the housing of the connecting arrangement in the closed state. In particular, the assembly seal can be arranged at least partially on a lateral surface of the assembly opening of the housing, for example on the outer wall and/or on the inner wall and/or on an end face of a lateral surface of the assembly opening.

The assembly seal can be arranged peripherally around the assembly opening. If the assembly opening closure covers the assembly opening, the seal can contact, in particular peripherally contact, both the assembly opening closure and the housing; in particular a gas-, liquid- and/or pressure-tight connection between the assembly opening closure and the housing can be achieved in this way.

A safety means can be arranged in the assembly opening. For example, a safety device can be arranged which is set up in such a way that it makes the busbars free of voltage as long as the assembly opening is open. When the assembly opening closure is open, the fuse can consequently ensure the busbars are kept voltage-free. For example, a manual service disconnect switch (MSD) can be provided for this purpose, which is actuated, for example, by the assembly opening closure. A High Voltage Interlock (HIVL) can also be provided, which also ensures the that the busbars are kept free of voltage when an assembly opening is open.

Some details of the connecting bolt and its connection to the corresponding busbar will now follow.

The joining region of at least one of the at least two connecting bolts or of the at least two connecting bolts can have a smaller diameter than the opening of the busbar in which the connecting bolt is arranged. The two diameters can also be approximately the same size, so that sufficient friction occurs, for example, during friction welding. The cross section of the joining region of the connecting bolt can increase at least slightly toward the contact region, so that the end face can at least partially be recessed from the joining region into the opening in the busbar before the welding. The diameter of the joining region is thus at least partially greater than the diameter of the opening of the busbar, in particular in a portion facing the contact region, and/or at least partially smaller than the diameter of the opening, in particular in a portion facing away from the contact region. For complete connection, welding energy, in particular by means of friction welding, in particular rotary friction welding, press butt welding, ultrasonic welding, etc., can be introduced into the connection between the connecting bolt and the busbar, so that parts of the busbar and/or parts of the connecting bolt plasticize. The connecting bolt can then penetrate into the busbar to the desired depth. In particular, the connecting bolt can penetrate radially to the longitudinal axis of the connecting bolt at least partially into the inner lateral surfaces of the opening of the busbar and/or can be integrally bonded thereto.

The contact region of at least one of the at least two connecting bolts can at least partially have a larger cross section than the opening of the corresponding busbar. In particular in the region of the transition between the joining region and the contact region of the connecting bolt, the contact region of the connecting bolt can have a larger cross section than the opening.

At least one of or the at least two connecting bolts can alternatively or additionally have a collar. The collar can protrude beyond the joining region, in particular about the entire periphery of the connecting bolt. Optionally, the collar can also protrude beyond the contact region, in particular about the entire circumference of the connecting bolt. The collar can have a round cross section at least in portions in the longitudinal axis. The collar of the connecting bolt can also at least partially have a substantially oval, angular, in particular triangular, quadrangular, pentagonal, or polygonal, a star-shaped or other cross section deviating from a round shape. A cross section of the collar deviating from a round shape can, for example, enable a friction welding tool to transmit a torque via the collar to the connecting bolt.

The collar of at least one of or of the at least two connecting bolts can be integrally bonded to the busbar. In particular, the connecting bolt can be integrally bonded to the collar on its own or to the joining region with the busbar.

The joining region can have a length which is greater than the thickness of the busbar. It can thus be achieved in particular that the connecting bolt, in particular the joining region of the connecting bolt, protrudes from the opening of the busbar in the connected state. The connecting bolt protrudes beyond the busbar in the direction of the surface normal to the wide side, thus on one side with the contact region, and on the other side of the busbar with the joining region running through the opening.

The technical effect of such a protrusion on both sides can be achieved in particular in combination with a through hole of the connecting bolt. This is the case in particular when a screw is guided through the through hole, by means of which screw the connecting bolt is fastened to a further element. In this case, the contact pressure of the screw on the corresponding connecting bolt is substantially completely absorbed by the connecting bolt and substantially not by the busbar. In particular in the case of busbars made of relatively soft materials such as aluminum, this has the advantage that the screw connection permanently holds and does not gradually lose contact pressure due to creep processes in the material of the busbar. For this purpose, the connecting bolt can be made of a material such as copper, which tends far less to deform under the permanent action of force than, for example, aluminum.

The contact region of at least one or the at least two connecting bolts is advantageously tapered in such a way that the lateral surfaces, the outer of the contact region of the connecting bolt and the inner of the recess, lie against one another, in particular lie against one another substantially over the entire surface. The contact region of the corresponding connecting bolt can thus be adapted to a recess. The contact resistance between the charging socket and the connection part is thus minimized. In particular, the lateral surfaces can have a substantially equal degree of taper. This means that in a side view, perpendicular to the longitudinal axis of the connecting bolt and/or the recess, the angle between this longitudinal axis and each of the lateral surfaces is substantially the same.

In particular, the inner lateral surface of the recess of the charging socket and/or the lateral surface of the contact region can be conical. In particular, the lateral surfaces can lie substantially over the entire surface against one another.

As described above, the connecting arrangement can have at least one retaining means. This can preferably engage in a side recess of the busbar. By means of the retaining means, the freedom of movement of the busbar along the longitudinal axis of the busbar can be limited and/or substantially prevented.

Alternatively or additionally to such retaining means, at least one guide element for at least one of the busbars or for the at least two busbars can be part of the connecting arrangement. The busbar can rest against a guide element with a wide side, a narrow side, the end face and/or a plurality of sides. The guide element can at least partially comprise the busbar, in particular its narrow side. For example, at least one guide rail can be provided which partially encompasses the busbar, for example. A groove in a housing inner wall can serve, for example, as a guide rail. Gripping elements having a recess which, for example, can be adapted to the narrow side of the busbar are also suitable as a guide element.

For example, at least one recess can be provided on at least one housing inner wall, wherein the recess can in particular be adapted to the thickness of the busbar. Guide elements protruding from the housing inner wall, which contain at least one recess for the busbar, in particular for its narrow side, are also possible.

The at least one guide element can be connected to the housing of the connecting arrangement, in particular can be rigidly connected. The at least one guide element can also be elastically connected to the housing. At least one guide element can be formed in one piece with the housing, for example cast, injection-molded and/or formed in one piece with the housing in another way.

In particular, both at least one guide element and at least one retaining means can be provided for at least one of the busbars; this can also be the case for the at least two busbars. In this way, a corresponding busbar can be inserted into the connecting arrangement in a controlled manner and held in a fixed position.

Guide elements can limit the freedom of movement of the busbar in particular in the direction of the surface normal to at least one of the wide sides of the busbar, in the direction in parallel with the longitudinal axis of the busbar toward the end face of the busbar and/or in parallel with the wide side perpendicular to the longitudinal axis.

Retaining means are in particular set up to counteract a movement of the busbar in parallel with the longitudinal axis out of the housing.

A guide element can be formed as a two-sided guide element. This comprises a contact surface which faces the receiving-opening-side wide side, and a contact surface which faces the assembly-opening-side wide side of the busbar. The distance between the two contact surfaces can in particular substantially correspond to the thickness of the busbar and/or the width of the narrow side. The movement freedom of the busbar is thus limited both in the direction of the assembly opening and in the direction of the receiving opening.

A two-sided guide element can thus comprise a recess which extends along the surface normal to the wide side of the busbar and along the width extension of the busbar.

The two-sided guide element can also comprise protrusions. The protrusions can each protrude into one of the two wide sides of the busbar. The contact surfaces of the two-sided guide element can be formed by the protrusions.

At least one guide element can be formed in such a way that a busbar does not necessarily have to be inserted into the guide element along the longitudinal axis of the busbar, but can be inserted perpendicularly to the transverse side of the busbar into the guide element.

A guide element can be a single-sided guide element for this purpose. A single-sided guide element has at least one contact surface on the side of the busbar which faces the receiving opening. The busbar can rest with the receiving-opening-side wide side on the at least one contact surface of the one-sided guide element. For this purpose, the contact surface can protrude into the wide side of the busbar, substantially in parallel with the wide side of the busbar. In this way, the busbar cannot overcome the guide element, more precisely its contact surface, in the direction of the receiving opening and/or in the plug-in direction of the connecting bolt. On the other wide side of the busbar, which points toward the assembly opening, the busbar is preferably not limited by the one-sided guide element or is only slightly limited thereby in a movement in the direction of the surface normal to the wide side of the busbar. For this purpose, the one-sided guide element preferably does not protrude into the other wide side. In parallel with the wide side, the one-sided guide element can at least partially limit the freedom of movement of the busbar. For example, it can have at least one contact surface which faces a narrow side of the busbar. This contact surface prevents the busbar from moving in parallel with the wide side of the busbar perpendicular to the longitudinal axis of the busbar, i.e., in parallel with the surface normal to the narrow side.

For example, a guide element can be formed as a click element. This can be realized, for example, as follows. A click element can have a first contact surface for the receiving-opening-side wide side of the busbar. This first contact surface can be formed, for example, similarly to the contact surface of the one-sided guide element. In addition, it is possible for the click element to provide a second contact surface on the assembly-opening-side wide side of the busbar. This second contact surface can be formed, for example, by a resilient element. For example, a resilient element can oppose an elastic restoring force relative to the wall of the housing of the connecting arrangement of a deformation in the direction of the housing wall. For example, the resilient element can be formed by an element which, starting from an assembly-opening-side fastening point in the direction of the receiving opening, extends substantially in the direction of the surface normal to the wide side of the busbar and pointing away from the housing wall. From the fastening point, the busbar can deform the resilient element in the direction of the wall. After passing the resilient element, the latter snaps back on the assembly-opening-side wide side of the busbar. The busbar is thus encompassed by the first contact surface on the side of the receiving opening and the second receptacle formed by the resilient element on the side of the assembly opening.

For example, two guide elements can also be arranged on at least one of the busbars. These can, for example, be arranged on both narrow sides of the busbar, for example at the substantially same position along the longitudinal axis of the busbar.

The guide elements can belong here to the types described above or can also assume other types. In each case, they can be the same types of guide elements or can be different types.

For example, in one embodiment, the smallest distance between two two-sided guide elements arranged on both sides, in particular in the width extension of the busbar, can be at least slightly smaller than the width of the busbar. By means of a force in the direction of the surface normal of the wide side of the busbar onto the busbar, the latter can reach into the guide elements with its narrow side. The guide elements then guide the busbar.

The at least one guide element of at least one of the busbars and the retaining means of the busbar can, for example, act on opposite sides of the busbar, for example on opposite narrow sides.

A guide element can also be provided on the end face of at least one of the busbars. A guide element on the end face can serve as an anti-twist means which counteracts rotations of the busbar about the longitudinal axis.

In particular in conjunction with guide elements on both sides on the narrow sides of the busbar, the latter can be guided into the connecting arrangement as far as a guide element for the end face of the busbar, inserted into the guide at the end face, and can latch into the guide elements on both sides by a tilting movement about the tilting axis running along the end face.

The busbar can be fixed at a distance from the housing inner wall in the housing, in particular by means of a guide element and/or retaining means. For example, the contact surfaces can be arranged at a distance from the housing wall for at least one wide side of a busbar and/or contact surfaces for at least one narrow side of the busbar.

Combinations of a plurality of the mentioned guide elements and/or of the mentioned retaining means are possible.

It is understood that the described guide elements and retaining means are only exemplary embodiments.

The retaining means can allow or not allow subsequent removal along the longitudinal axis of the busbar. For example, this can be determined by the shape of the side recess and/or the of retaining element, among other things. For example, a recess with a semicircular or otherwise at least partially rounded shape can allow removal. However, a recess with, for example, an angular, for example rectangular, cross section can impede a removal. The shape of the retaining means engaging in the recess can also make removal more difficult or easier. The retaining means can, for example, have an angular shape that is suitable for the recess and makes removal more difficult. The retaining means can also have a rounded shape and thus facilitate the removal of the busbar from the connecting arrangement.

At least one of the retaining means and/or the guide elements can be designed to be substantially rigid, so that the busbar can only move to a very limited extent when it is connected to the guide element and/or is held by the retaining means. The retaining means and/or the guide element can also be designed flexibly so that the busbar can rotate by a few degrees, for example, even if it is already inserted in the guide element and/or the retaining means. For example, spring elements can be provided for the guide element and/or retaining means. They can also be formed at least partially from an elastic material such as rubber, silicone, plastics material or other elastic materials.

In particular, at least one of the retaining means and/or one of the guide elements is formed from a non-conductive material and/or is formed as part of the housing and/or formed in one piece with at least a part of the housing.

A substantially immovable connection between at least one, preferably the at least two busbars and the housing of the connecting arrangement can be advantageous. For example, in the case of a rigid connection of the busbar to a further element, for example, when the connecting bolts are screwed to recesses of a charging socket, the latter can also be fixed by the rigid connection of the busbar to the connecting arrangement housing. The number of required fastening operations during assembly thus reduces to a minimum.

A busbar with a connecting bolt connected thereto is significantly more difficult to connect with a connecting arrangement than a simple flat busbar without a connecting bolt. At the same time, it is not possible to first arrange the connecting bolt in an integrally bonded manner in a housing on the busbar. This is because the housing cannot withstand the resulting temperatures in many cases. In addition, production in this way would be costly. In the present case, for overcoming the complications, inter alia, the housing part is proposed which guides the busbar in a sealed manner into the housing of the connecting arrangement. Guide elements, as described above, can also be formed in such a way that they can be inserted into the connecting arrangement in a plane which, compared to the end position of the busbar, is displaced in the direction of the surface normal to the wide side of the busbar. The busbar can then latch into at least one guide element and/or retaining means.

A further element, already inventive per se, of the present connecting arrangement is a locking element.

The locking element is formed from a non-conductive material, for example plastics material, for example a high-temperature plastics material, for example from substantially the same material as at least parts of the housing.

The locking element can be designed to be separate, in particular separable, from the housing. It can be arranged in the housing of the connecting arrangement. In particular, the locking element can be arranged in a region between a busbar and the assembly opening in the housing of the connecting arrangement. The locking element can protrude from the housing via the assembly opening.

In particular, the cross-sectional area of the locking element can be smaller than that of the assembly opening and/or at least partially substantially the same cross-sectional area; thus, the locking element can be inserted into the assembly opening. In one embodiment, the locking element is at least partially cross-sectionally matched to at least a part of the assembly opening. The locking element can in particular be arranged at least partially form-fittingly in at least a part of the assembly opening.

The locking element can rest against at least one busbar and can be connected at least form-fittingly to at least a part of the housing, for example by means of a latching means. For example, the locking element can be arranged between at least one busbar and an inner wall of the housing of the connecting arrangement, wherein the inner wall faces in particular the busbar. In particular, it can be arranged in a captive, form-fitting, frictionally engaged manner or in a press fit between at least one busbar and a part of the housing, in particular an inner wall of the housing. In particular, this inner wall of the housing can point toward the busbar. The locking element can be arranged in front of the busbar in the plug-in direction of the at least one connecting bolt of the at least one busbar. The locking element can be arranged at least partially in the assembly opening. The locking element can be in direct and/or indirect contact with at least one of the busbar and/or the at least one connecting bolt in the busbar.

The length of at least one part of the locking element can substantially correspond to the distance between the wide side of the busbar facing the assembly opening and/or the connecting bolt, which extends through the busbar on this side, on the one hand, and a part of the inner wall of the housing in the region of the assembly opening, which part is of the busbar, on the other hand. The locking element can consequently rest with such a dimensioned part both on one of the busbars and/or a connecting bolt of one of the busbars from the side of the assembly opening and can also rest against a housing inner wall of the connecting plug facing the busbar.

In this way, the locking element can, for example, be used to introduce the busbar into at least one guide element in the direction of the surface normal to the wide side of the busbar. A force can be exerted on the busbar by means of the locking element.

In particular, the locking element fulfills a holding function and/or a guide function for the busbar. In particular, the busbar is fixed by the locking element in the direction of the surface normal to the wide side, which faces the assembly opening.

The locking element is in particular useful in conjunction with one-sided guide elements. These fix the busbar to the side of the receiving opening; the locking element fixes the busbar to the side of the assembly opening.

So that the locking element does not move or only slightly moves in parallel with the wide side of at least one of the busbars, the locking element can always remain partially in the assembly opening, in particular within a region which is encompassed by the lateral surfaces of the assembly opening. The locking element can have a length which, starting from the wide side of the busbar and/or of the connecting bolt facing the assembly opening, extends in the busbar into the region encompassed by the lateral surfaces of the assembly opening. In this case, the busbar is in particular in contact with at least one of the guide elements, which limits the freedom of movement of the busbar in the direction of the receiving opening. In particular, the locking element can be arranged form-fittingly in at least a part of the assembly opening, in particular in a region encompassed by a lateral surface of the assembly opening. For example, the lateral surfaces can form an opening with a first cross section, for example with a round, angular or other shape. The assembly-opening-side end of the locking element can have a cross section adapted thereto, for example likewise round, angular or correspondingly shaped in another manner.

So that the locking element remains in the housing of the connecting arrangement, it can have at least one latching means. The latching means can be spaced apart from the assembly-opening-side end of the locking element in the extension direction of the connecting bolt. The at least one latching means can, for example, protrude from the locking element substantially perpendicularly to the extension direction of the connecting bolts. The latching element can be elastically compressed when it is passed through the assembly opening, so that the locking element fits through the assembly opening, and can expand again within the housing. This makes it difficult to remove the locking element from the housing.

The locking element can remain in the housing of the connecting arrangement. The locking element has a recess, in particular a through hole, so that the connecting bolts and in particular the through hole in each of the connecting bolts remain reachable through the assembly opening. In the plugged-in state, the through hole of the locking element extends in the extension direction of the connecting bolt of the busbar with which the locking element makes contact. The through hole of the locking element can be aligned with the through hole of the connecting bolt. The through hole of the locking element has in particular a larger diameter than the through hole of the connecting bolt. In this way, a screw for fastening the connecting bolt together with the screw head can be guided through the through hole of the locking element up to the connecting bolt and/or the busbar.

The locking element can also limit access to the connecting bolt in such a way that only precisely one connecting bolt can be reached by the locking element, in particular through the through hole of the locking element.

A locking element can also have more than one through hole. The locking element can, for example, in each case have a through hole for a connecting bolt.

In an advantageous embodiment, the busbar is held rigidly by the guide and/or the retaining means in particular in the direction of the surface normal to the wide side of the busbar, in particular in the direction of the receptacle opening, in particular in the direction of the longitudinal axis of at least one of the connecting bolts, in particular in the plug-in direction. This hold can be brought about by at least one of the guide elements and/or the retaining means. For this purpose, a guide element can have a contact surface on the receiving-opening-side wide side of the busbar, as already described hereabove. Via the at least one guide element, a contact pressure acting on the connecting bolt can be transmitted to the connecting arrangement, in particular to its housing in the direction of the longitudinal axis of the connecting bolt and/or to the surface normal of the wide side of one of the busbars. In particular, a contact pressure starting from the connecting bolt can be transferred to the housing of the connecting arrangement in the plug-in direction of the connecting bolt.

In parallel with the surface of the wide side of at least one of the busbars, the busbar can be held in a manner fixed less strongly in the connecting arrangement than in the direction of the surface normal to the wide side. For example, an elasticity of the guide element and/or retaining means can be provided in this direction. In particular, a limited contact surface can be provided in the connecting arrangement, in particular on a guide, and, although it allows a force transfer from the busbar to the housing in the direction of the plug-in direction of the connecting bolts, nevertheless permits the busbar to be tilted. For example, the contact surface can be arranged on the housing or a retaining means and/or guide element connected to the housing in the region of the through hole, in particular on opposite sides of the through hole of at least one of the busbars.

The at least two busbars can be arranged, in particular fixed, next to one another in the housing. In particular, the at least two busbars can be arranged in such a way that a narrow side of a first of the busbars is directly adjacent to a narrow side of a second one of the busbars. A gap can remain between the busbars; the busbars can also rest directly on one another, in particular with their insulating layer.

The busbars can be arranged at least partially in parallel in the connecting arrangement. At least in one end region, in particular in the region of the connecting arrangement, the busbars can be, for example, at the same height in the direction of the surface normal on the wide side of at least one of the busbars. The wide sides of at least two busbars, in particular the wide sides which face the receiving opening, can lie in one plane.

In the case of busbars arranged next to one another, the side recesses can be arranged, for example, on the outer narrow sides of the busbars. Side recesses can also be arranged on the inner narrow sides. Outer narrow sides of a busbar have at least one corresponding other busbar. Inner narrow sides of a busbar face at least one other busbar.

The connecting bolts of the at least two busbars can be substantially equal in length, starting from the busbar surface from which the connecting bolts depart, measured in the extension direction of the connecting bolt. The connecting bolts of the at least two busbars can also substantially be aligned perpendicular to the longitudinal axis of at least one of the busbars.

The at least two busbars can be constructed substantially mirror-symmetrically relative to one another, in particular about the longitudinal axis of at least one of the busbars. For example, the position and/or shape of the connecting bolt and/or the position and/or shape of a side recess of one of the busbars can be designed substantially mirror-inverted to another of the busbars.

A further aspect is a charging socket according to claim 39.

The present charging socket comprises at least one first receptacle for a charging plug. This charging plug can originate, for example, from a charging station. This can be, for example, a Mode-2, Mode-3, Type-1 or Type-2 plug. In particular, the plug can have connections for charging by direct current. For example, the plug can be a Combined Charging System (CCS), CHAdeMO, a Tesla® Supercharger plug, or another plug with direct current contacts.

The charging socket can comprise a charging socket housing. The charging socket housing of the charging socket can be formed from a non-conductive material, for example from plastics material, for example from high-temperature plastics material, for example PA6GF15, UL94, or another plastics material which is suitable for high temperatures. Materials such as ceramic, glass or the like are also possible.

The first receptacle for the charging plug comprises, for example, a recess in the charging socket, in particular in the charging socket housing of the charging socket, into which the charging plug can be inserted. A closure can also be provided on the first receptacle, in particular an openable closure. For example, a flap can close the first receptacle for the charging plug. For example, the flap can close automatically, for example spring-loaded, so that the receptacle is closed without an inserted charging plug. The first receptacle further comprises at least two contact pins. The contact pins can be arranged in the first receptacle. During insertion into the first receptacle, the charging plug can be contacted with at least one of the at least two contact pins. At least one of the contact pins can serve, for example, for contacting a control line, alternating current line, direct current line, or another type of line.

The first receptacle can be adapted to a plug face of the charging plug and is usually suitable for a specific type of charging plug.

In addition to the first receptacle for a charging plug, the charging socket comprises a second receptacle for a connecting arrangement. The second receptacle can, for example, at least partially form an above-mentioned connection part which can be inserted into the receiving opening of a present connecting arrangement. In particular, the second receptacle can be at least partially adapted to the cross section of the receiving opening of the connecting arrangement, in particular in such a way that the outer cross section of at least a part of the second receptacle can be received completely by the inner cross section of the receiving opening of the connecting arrangement. The second receptacle can comprise a recess in the charging socket, in particular in the charging socket housing of the charging socket. In particular, the second receptacle can comprise a base on the charging socket, in particular a base of the charging socket housing of the charging socket or, for example, a separate component which protrudes from the charging socket in the form of a base. The receptacle can also comprise a contact surface of the charging socket, in particular on the charging socket housing of the charging socket. The contact surface can in particular be arranged peripherally around the receptacle, whether a base or a recess.

Retaining means, for example form-fitting and/or frictionally engaging retaining means, for example hooks, threads for screws, in particular threads formed in the charging socket housing of the charging socket, in particular made of a metal material, or similar retaining means can be provided on the charging socket. The retaining means can in particular be arranged in the region of the second receptacle.

At least one seal can be arranged on at least parts of the second receptacle and/or the contact surface. For example, a seal can be arranged in a closed form, for example in a ring, rectangle, oval or other closed forms on the second receptacle and/or the contact surface. The seal can surround at least a part of the second receptacle. The seal can be manufactured, for example, from an elastic material, in particular from a plastics material, rubber, silicone, or similar materials. The seal can also be produced in one piece with the charging station housing in a two-component injection molding process.

The first receptacle, in particular the shape of the charging socket housing and/or the arrangement of the at least one plug-in peg, can be adapted to a plug face of the charging plug. The first receptacle can be suitable for a certain type of charging plug.

At least one plug-in peg can be arranged at least partially in the first receptacle. For example, the plug-in peg can be arranged in a plug connector. Parts of the plug connector can at least partially surround the plug-in peg, for example.

At least parts of the at least one plug-in peg are arranged in the first receptacle. The plug-in peg can serve, for example, as a contact pin of the charging socket and/or a charging plug. During insertion into the first receptacle, the charging plug can be contacted with at least one of the plug-in pegs. For example, the plug-in peg can serve as a contact pin for, for example, a control line, alternating current line, direct current line or another type of line.

The plug-in peg is made of a conductive material. In particular, the plug-in peg can be formed from a metal material. For example, the plug-in peg can be formed at least partially from copper, aluminum, iron, gold, silver, or other metal, and/or alloys thereof.

It can be advantageous to coat the plug-in peg at least partially. In particular, a metal coating can be advantageous in order, for example, to avoid contact corrosion, to reduce transition resistances and/or to make the plug connector more durable. For example, at least one of the plug-in pegs can be coated with silver, gold, copper, aluminum, nickel and/or further metals and/or alloys thereof. The coating can substantially completely cover the plug-in pegs or can be attached only to selected regions. For example, a coating can be applied in the region of the recess and/or on the second region of the plug-in peg. It is also possible to provide a plug-in peg with a double coating, for example an inner nickel layer and an outer silver layer.

In a preferred embodiment, at least one plug-in peg is formed from copper, in particular from E-copper. This can be coated with silver, in particular with silver having a nickel sublayer.

The plug-in peg comprises at least two opposing end faces. These can be substantially flat. Also possible is a surface of the end faces that deviates from a flat shape, for example a rounded shape, a tapered shape, in particular a saddle-shaped tapering or another surface shape of the end faces.

Starting from the first end face, a first region of the plug-in peg extends to a central region of the plug-in peg. Starting from the second end face, which lies opposite the first end face, a second region extends to the central region of the plug-in peg.

In the charging socket, the plug-in peg extends from the rear side of the charging socket into the receptacle for the charging plug. In particular, a first region of the plug-in peg extends from the rear side toward the receptacle. A second region of the plug-in peg extends at least partially into the receptacle. In particular, the second region can thus serve at least partially as a contact pin for a charging plug.

The central region can have an extension in the longitudinal direction of the plug-in peg. The central region can comprise here parts of the first and/or the second region. The central region can also define a further region of the plug-in peg different from the first and second regions. The central region can substantially lie along the longitudinal axis at half the length of the plug-in peg. The central region can also be arranged further away from one of the end faces than to the other end face.

The cross section of the first region can be greater than the cross section of the second region. Both regions can also have a substantially identical cross section.

In addition to the first end face, the first region of the plug-in peg can have a further end face. This further end face can be oriented substantially facing away from the first end face. The further end face points in the direction of the second region. The further end face can be substantially flat. Also possible is a surface of the further end face that deviates from a flat shape, for example a rounded shape, a tapered shape, in particular a saddle-shaped tapering or another surface shape of the further end face.

The cross section of a plug-in peg is here to be determined substantially perpendicular to the longitudinal extent of the plug-in peg. A larger cross section is accompanied, inter alia, by an increased material volume and thus with an increased thermal capacity of the plug-in peg.

If a first cross section is specified greater than a second cross section, it can be understood here that the cross-sectional area of the first cross section is greater than the cross-sectional area of the second cross section. It can also be understood that the first cross section has a higher diameter in at least one direction than the second cross section. It can also be understood that the first cross section can completely surround the second cross section.

A plug-in direction can be defined for a plug-in peg. This can in particular be defined substantially in parallel with the longitudinal axis of the plug-in peg and can extend from the first region to the second region of the plug-in peg.

A recess is arranged in the first end face of the plug-in peg and can be suitable for receiving a connecting bolt, in particular a connecting bolt of a connecting arrangement. The recess can extend in parallel with the longitudinal axis of the plug-in peg in the direction of the central region of the plug-in peg. The recess can have a substantially round cross section; the cross section can also be elliptical, angular, in particular triangular, quadrangular, pentagonal or polygonal or shaped in some other way deviating from a round shape.

The cross section of the recess can be substantially constant along the longitudinal axis of the plug-in peg. The cross section can also taper in particular along the longitudinal axis in the direction of the central region of the plug-in peg, in particular linearly, so that the cross section decreases linearly with increasing penetration depth of the recess into the first region of the plug-in peg. The cross section of a recess can decrease uniformly at all sides perpendicular to the extension direction of the recess, for example perpendicular to the longitudinal axis of the plug-in peg. The cross section can also decrease more strongly in a direction perpendicular to the longitudinal axis than in another direction. In particular, an asymmetry of the recess can be achieved in this way, which makes it possible to insert a correspondingly shaped bolt only in one angular position about the longitudinal axis.

In a preferred embodiment, the recess is conically shaped.

This recess can also be defined as belonging to the charging socket.

A blind hole can be provided in the recess of at least one of the plug-in pegs. In particular, a thread can be provided in the blind hole. The blind hole can end in the first region of the plug-in peg. In some cases, it is also possible for the blind hole to protrude into the second region. The blind hole, in particular with thread, enables a fixed screw connection of a connecting bolt in the recess. A high contact pressure between the connecting bolt and the recess can be achieved. A particularly low-resistance transition between a connecting bolt and the plug-in peg can thus be produced.

In particular in combination with a tapering, in particular conical recess, a likewise tapered, in particular conical, connecting bolt in the recess by means of the thread in the blind hole and a screw can be permanently fixedly and effectively connected in a manner having good conduction. The connecting bolt can originate from the connecting arrangement, in particular as described above.

At least one of the recesses of the charging socket and/or one of the pins can be arranged in the second receptacle. In particular, this can be arranged within a corresponding recess of the charging socket housing of the charging socket. The receptacle, in particular surrounded by a raised portion of the charging socket, can also protrude from the charging socket housing.

The charging socket can comprise a contact region. This can, for example, be arranged in the region of the second receptacle, in particular can surround it at least partially or also completely, in particular peripherally. For example, the seal in the contact region can be arranged, in particular peripherally around at least one of the recesses.

In the case of a base within which at least one of the recesses is located, with a lateral surface partially forming the base, the contact surface can also be arranged on at least parts of the lateral surface.

The charging socket furthermore comprises a connecting arrangement. This is arranged for example on the second receptacle of the charging socket. In particular, the connecting arrangement can be in mechanical contact with the charging socket. In particular, the charging socket housing can be in contact with the housing of the connecting arrangement, in particular in the housing of the connecting arrangement, in particular in the receiving opening. The connecting arrangement can be connected to at least one of the at least two recesses of the charging socket, in particular to at least one of the connecting bolts. This can in particular be an electrical connection. In particular, at least one of the connecting bolts can be connected at least form-fittingly, in particular also in a frictionally engaged manner, to at least one recess.

The through hole of at least one of the connecting bolts and/or of the at least two connecting bolts can substantially be aligned with the blind hole in the recess.

The recess and the connecting bolt can each have tapered lateral surfaces which, in particular, fit into one another at least partially form-fittingly. For this purpose, the recess and the connecting bolt can have the same degree of taper, for example.

The connecting arrangement can be in mechanical contact with the charging socket housing of the charging socket. For example, the connecting arrangement can rest on the contact region of the charging socket, in particular on the seal in the contact region. The connecting arrangement can substantially peripherally surround at least one of the recesses and/or at least one of the connecting bolts on the charging socket and in particular can enter into a liquid-, gas- and/or pressure-tight connection to the charging socket. The charging socket can penetrate the connecting arrangement with the receptacle, and the connecting arrangement can conversely also penetrate the charging socket on the receptacle.

In particular, the recesses of the charging socket can be highlighted in the direction of the connecting arrangement relative to the contact region on the charging sockets, with which the connecting arrangement contacts in the connected state. The recesses can in particular be arranged in a base which protrudes beyond the surface of the charging socket housing of the charging socket surrounding it in the direction of the connecting arrangement, in this way also connecting bolts of the connecting arrangement can contact the recesses of the charging socket which do not protrude beyond the receiving opening of the housing of the connecting arrangement.

For example, at least one retaining means can hold the connecting arrangement on the charging socket. This can be a frictionally engaging and/or form-fitting retaining means, for example a screw element, clamping element, latching element, a hook, or another retaining means. In particular, the at least one retaining means can effect a contact pressure between at least parts of the charging socket and at least parts of the connecting arrangement. At least a part of the at least one retaining means can be arranged on the connecting arrangement. For example, a hole for a screw can be provided on the connecting arrangement, while a screw receptacle, for example a thread, is provided on the charging socket. A screw receptacle can comprise a thread which is embedded in the charging socket housing, in particular a thread made of a metal material. At least one hook can also be arranged on the charging socket, while a contact region for the hook is provided on the connecting arrangement. A hole for a screw can comprise a feedthrough formed in the connecting arrangement with a through hole, for example made of a metal material. The screw can, for example, be arranged in a captive manner in the hole. A hole for a screw can also be formed by the through hole in at least one of the connecting bolts.

In one embodiment, the retaining means of the charging socket is arranged in the region of at least one of the recesses. For example, a thread can be arranged in the recess, in particular in the blind hole. On the connecting arrangement, a through hole in one of the connecting bolts can be suitable for guiding a screw through it. The screw can then engage in the thread of the recess in the blind hole and connect the connecting bolt to the recess, in particular with a contact pressure exerted by the screw. The connecting arrangement can thus be held directly on at least one of the recesses of the charging socket via at least one of the connecting bolts and can be held in particular both on the recess and on the contact surface for the connecting arrangement.

The connecting arrangement is connected, in particular electrically connected, to at least one of the recesses of the charging socket.

In particular, at least one connecting arrangement arranged on the second receptacle of the charging socket is connected to the charging socket. In particular, at least one of the connecting bolts of the connecting arrangement is arranged in the recess in a form-fitting and/or frictionally engaged manner. In particular, the connecting bolt is screwed to the recess by means of a screw guided through the through opening of the connecting bolt, in particular by means of the blind hole within the receptacle, which in particular has a thread. In particular, both connecting bolts can be arranged in a corresponding recess in this manner.

In particular, both at least two of the connecting bolts of the connecting arrangement can be arranged in a frictionally engaged and/or form-fitting manner in a corresponding recess of the charging socket. In addition, the housing of the connecting arrangement can be in contact with the charging socket in a contact region which peripherally encompasses the connecting bolts and the recesses. In particular, this contact can be realized indirectly via a seal, which is arranged in particular in a press fit between the charging socket and the connecting arrangement. The contact region can in particular be the lateral surface of a base of the charging socket. In this case, a seal on the inside of the lateral surface of the receiving opening can ensure a good sealing effect at different insertion depths of the base into the receiving opening.

A further aspect is a system according to claim 41.

A charging socket according to the invention can be connected to a connecting arrangement according to the invention. In particular, one of the connecting bolts of the connecting arrangement can be connected to a recess of the charging socket, in particular electrically connected. The connecting arrangement can also be in mechanical contact with the charging socket. In particular, the connecting arrangement can be in contact with the charging socket peripherally around at least one of the connecting bolts, for example on a contact region of the charging socket, for example indirectly via a seal arranged therebetween. The housing of the connecting arrangement can contact directly with the charging socket and/or a seal can be arranged between the two, via which the connecting arrangement indirectly contacts the charging socket. The charging socket and connecting arrangement can be fixedly connected to one another. For this purpose, at least one retaining means can be arranged on the charging socket and/or on the connecting arrangement, in particular in form-fitting and/or frictionally engaging retaining means. In the case of connecting bolts with through holes, a screw connection can be carried out between at least one of the connecting bolts and one of the recesses. The housing of the connecting arrangement can also be connected to the charging socket, for example to the charging socket housing of the charging socket, by means of retaining means. For example, these two can also be screwed. In particular, the screw connection of the connecting bolt to the recess already causes a sufficient hold between the connecting arrangement and the charging socket, so that these do not have to be additionally fastened to one another.

The subject matter is explained in greater detail below with reference to drawings showing exemplary embodiments. In the drawings:

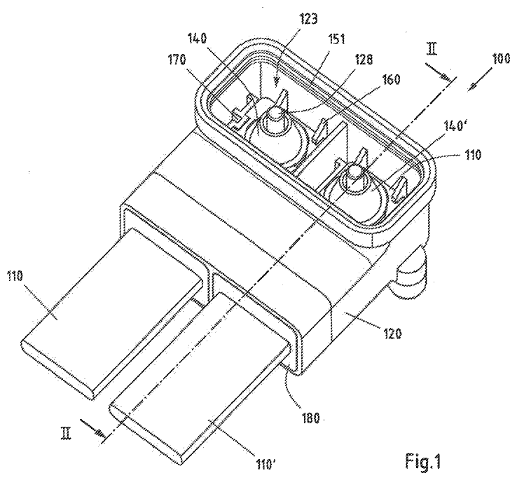

FIG. 1 shows a connecting arrangement according to the invention in accordance with an exemplary embodiment in an isometric representation;

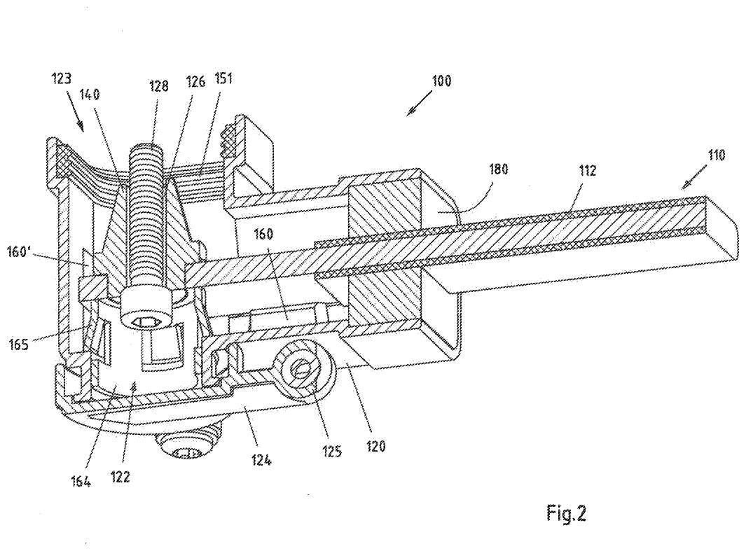

FIG. 2 shows a connecting arrangement according to the invention in accordance with an isometric sectional view;

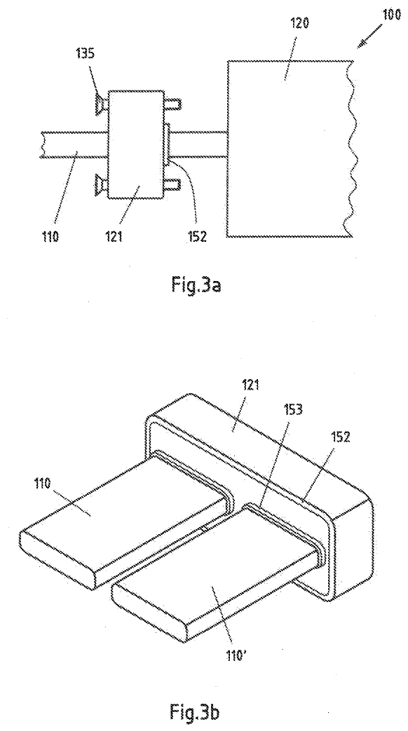

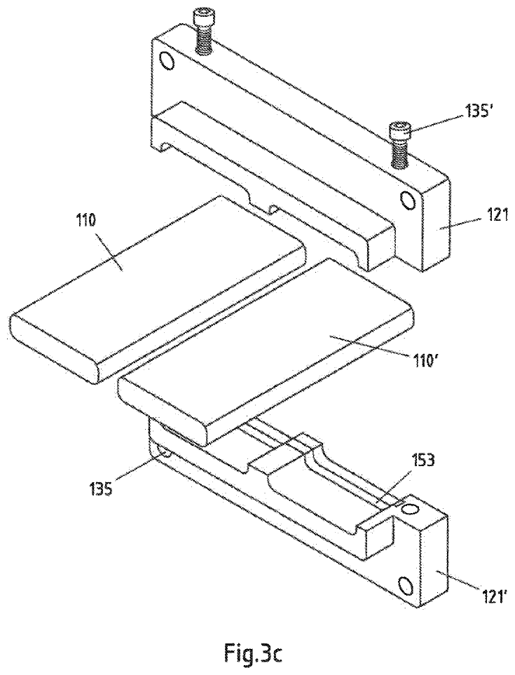

FIG. 3a-c show housing parts according to exemplary embodiments;

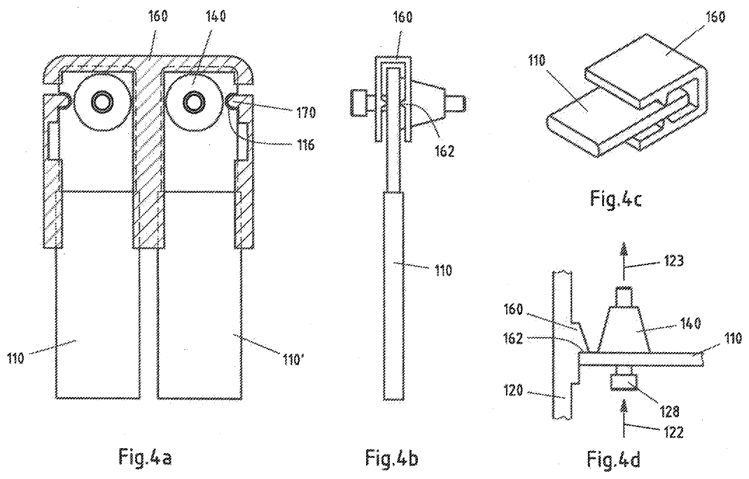

FIG. 4a-d show guide elements and retaining means according to exemplary embodiments;

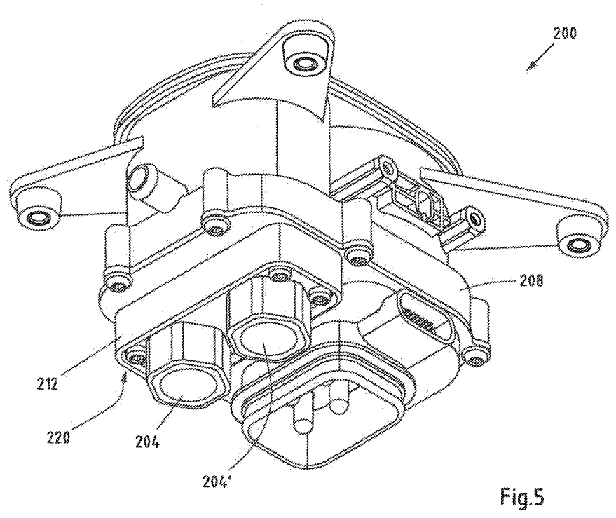

FIG. 5 shows a charging socket according to the invention in accordance with an exemplary embodiment in an isometric representation;

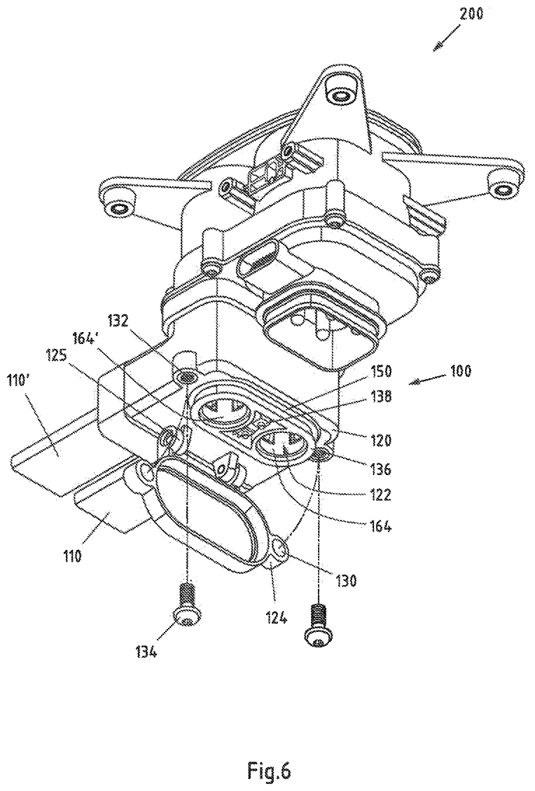

FIG. 6 shows a connecting arrangement according to the invention on a charging socket according to the invention in accordance with an exemplary embodiment in an isometric representation;

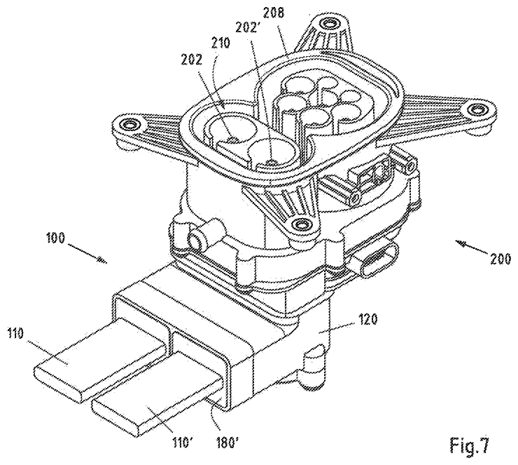

FIG. 7 shows a connecting arrangement according to the invention on a charging socket according to the invention in accordance with an exemplary embodiment in an isometric representation.

FIG. 1 shows a connecting arrangement 100 according to the invention in accordance with an exemplary embodiment. This comprises a housing 120 in which two busbars 110, 110′ are guided. The busbars 110, 110′ are guided through a housing part 180 into the housing. A receiving opening 123 can also be seen. Located therein are two connecting bolts 140, 140′ connected to a busbar 110, 110′ each. The connecting bolts 140, 140′ each have a through hole 126 in which, for example, a screw 128 can be arranged. Furthermore, guide elements 160 can be seen in the housing. These are set up to fix the busbar 110 in a position within the housing 120. In particular, it can be seen that the guide elements 160 protrude partially into the wide side of the busbar. In this way, the busbar 110 rests against the guide elements 160 in the direction of the receiving opening 123. Furthermore, a retaining means 160 is visible which fixes the busbar 110 along its longitudinal direction. A seal 151 is arranged on the inner wall of the receiving opening 123. In the embodiment shown, this is equipped with a plurality of ribs and/or sealing lips.

FIG. 2 shows an isometric sectional view of the connecting arrangement 100 according to the invention in accordance with an exemplary embodiment. FIG. 2 shows, more clearly than in FIG. 1, a busbar 110 with an insulation 112. The insulation 112 is merely indicated by the thickness of the busbar 110. The housing 120, more precisely the housing part 180, are cross-sectionally adapted to the busbar 110, so that it can be guided into the housing 120 in a sealed manner, in particular in a gas-, liquid- and/or pressure-tight manner.

The housing has a receiving opening 123. The seal 151 on the inner lateral surface of the receiving opening 123 can be clearly seen here, as can also the ribs thereof. An assembly opening 122 is arranged on the side of the connecting arrangement facing away from the receiving opening 123. This opening can be closable by an assembly opening closure 124. The assembly opening closure 124 can be held on the housing 120, for example by retaining means 125, for example by a shown hinge 125. At least a part of at least one of the connecting bolts can be exposed through the assembly opening 122, so that, for example, the through hole 126 and/or a screw 128 arranged therein can be reached by means of a tool, for example by means of a screwdriver 129.

FIG. 2 also shows guide elements 160. These can be located on a longitudinal side of the busbar 110. A guide element 160 that is resilient relative to the housing wall is shown on the longitudinal axis. This is formed in the housing wall of the housing 120. When a busbar 110 located below the guide element 160 in the direction of the assembly opening 122 is displaced into a position above the guide element 160, the guide element 160 can deflect in the direction of the housing wall, let the busbar 110 pass, and then spring back elastically under the busbar 110. The busbar 110 can thus be arranged in the guide element 160 after the complete insertion into the housing 120. The shown guide element 160 is an embodiment of a click element 160 according to the invention.

Guide elements 160′, as was already apparent in FIG. 1, can also be arranged on the end face of the busbar 110. These protrude into the wide side in particular as one-sided guide elements only on the assembly-opening-side wide side of the busbar 110. A busbar 110 can thus also be brought closer to the guide element 160′ from the side of the assembly opening, on these guide elements 160′.

The structure of the locking element 164 can be seen particularly well in FIG. 2. This comprises a substantially round lateral surface. The lateral surface is at least partially cross-sectionally adapted to the assembly opening 122, so that it can in particular be inserted through it into the housing 120 of the plug arrangement 100. The lateral surface is perforated by outwardly pointing latching means 165. In the force-free state, the latching means 165 protrude beyond the edge of the assembly opening 122. These can be distributed symmetrically around the lateral surface. For example, 4 uniformly distributed latching means 165 are shown. One latching means 165 extends over a central region of the lateral surface in the longitudinal direction of the locking element 164. Both relative to the busbar 110 and to the assembly opening 122, the locking element 164 has a peripherally closed lateral surface. The locking element 164 can be at least partially, preferably completely inserted through the assembly opening into the housing 120 of the connecting arrangement 100. The length of the locking element 164 in its longitudinal direction starting from its busbar-side end face to the assembly-opening-side end of at least one latching means 165 can substantially correspond to the distance between the wide side of the busbar 110 resting against at least one guide element 160′ and an inner wall of the housing 120 on which the snap element 165 rests. The locking element can protrude beyond the assembly-opening-side end of at least one of the snap elements 165, in particular into the assembly opening 122, in particular into the region enclosed by the lateral surfaces of the assembly opening 122. The assembly-opening-side end of the locking element 164 is thus spaced apart from the latching means 165, in particular in the extension direction of the connecting bolt 140.

The latching means 165 prevent the locking element 164 from being removed. The locking element 164 thus fixes, in particular in combination with at least one of the guide elements 160, the busbar 110 in its position.

The locking element 164 is arranged between the inner wall of the housing 120 and the busbar 110, in particular in a form-fitting and/or frictionally engaged manner.

In the inserted state, the locking element 164 is also arranged partially in the assembly opening 122 with extended latching means 165. In particular, the locking element 164 extends into the lateral surface of the assembly opening 122. In this way, the locking element 164 is also held in its position perpendicular to the extension direction of the connecting bolts 140, 140′. In particular, the locking element 164 rests at least partially against the inner side of the lateral surface of the assembly opening.

In particular, the locking element 164 can be cross-sectionally adapted to at least a part of the assembly opening 122, for example a part of the assembly opening 122 which is formed by a lateral surface 136. The locking element 164 can be arranged in a form-fitting manner in the assembly opening 122.

FIG. 3a-c shows the passage of the busbars 110, 110′ into the connecting arrangement 100, in particular in the housing 120 thereof, in particular by means of a housing part 180. As shown in the preceding figures, the housing part 180, which can in particular be separated from the housing, can surround the busbars 110, 110′. It can comprise an opening adapted to the busbars 110, 110′ or two openings adapted to one each of the busbars 110, 110′.

FIG. 3a shows an embodiment of a housing part 121 which can be fastened to the housing 120 of the connecting arrangement 100, in particular in a frictionally engaged and/or form-fitting manner. For example, retaining means 135, in particular holes for screws 135 on the housing part 121, can be provided for this purpose. Corresponding screw receptacles can be provided on the housing 120. In addition, in the connected state, a seal 152 can be arranged between the housing 120 and the housing part 121. In the exemplary embodiment shown, this seal 152 is arranged on the housing part 121. The seal 152 can in particular comprise the busbars 110, 110′ jointly and/or individually, in particular peripherally.

FIG. 3b shows an exemplary embodiment of a housing part 121 having two separate openings for busbars 110, 110′. Seals 153 can be provided around the openings; a seal 152 can also be arranged around the housing part 121.

FIG. 3c shows a further embodiment of a housing part 121 which comprises two parts 121, 121′, which can laterally surround two busbars 110, 110′. Here too, a seal 153 can enclose the busbars. Retaining means 135′, for example screws, can hold together the parts 121, 121′. Retaining means 135 for fastening the housing part 121 to the housing 120 can also be provided.

FIG. 4a shows an example of retaining means 170 and guide elements 160 within the housing 120 of the connecting arrangement 100. The busbars can each comprise a side recess 116. A retaining means 170 can engage therein. A retaining means 170 is shown which substantially corresponds to a latching lug which engages in the side recess 116 due to the elasticity of the material of the retaining means 170. Furthermore, a guide element 160 is shown. This at least partially surrounds the busbars 110, 110′. The busbars 110, 110′ are held by the guide elements 160, in particular in a direction perpendicular to the wide side of the corresponding busbar 110, and/or from the retaining means 170, in particular along the longitudinal axis of the corresponding busbar 110. Both the guide elements 160 and the retaining means 170 are connected to the housing 120, in particular rigidly connected.

FIG. 4b, c show a further example of a special embodiment of a guide element 160. This has a bearing region 162 in the form of a raised portion which extends substantially through the through hole from the connecting bolt 140 and/or from the busbar 110 perpendicular to the longitudinal axis of the busbar 110. This contact region 162 enables a force transfer from the busbar 110 to the guide element 160 and thus to the housing 120. At the same time, a tilting of the busbar 110 relative to the guide element 160 is possible. The variant shown allows, in particular, a rigid guide in the direction of the extension direction of the connecting bolts and at the same time a flexible guidance against tilting of the busbar 110. Assembly is thus simplified.

FIG. 4d shows a one-sided guide element 160 according to the invention. This has a contact surface 162 on the side of the receiving opening 123 of the busbar 110. The contact surface 162 can in particular counteract a displacement of the busbar 110 in the direction of the surface normal to the wide side of the busbar 110 in the direction of the receiving opening 123 of the connecting arrangement 100 and/or in the plug-in direction of at least one of the connecting bolts 140, 140′, while a displacement starting from the one-sided guide element 160 in the direction of the assembly opening 122 is possible. It can also be seen that the one-sided guide element 160 detects a distance between the busbar 110 and the housing wall. For this purpose, the one-sided guide element 160 protrudes from the housing wall with an assembly-opening-side region which is arranged in front of the contact surface in the plug-in direction.

FIG. 5 shows a charging socket 200. This has two recesses 204, 204′. These are arranged in particular in a marked base 220. The base 220 has a lateral contact surface 212 which is a lateral surface of the base.

The recesses can be marked in the direction of the connecting arrangement 100 from the charging socket 200. If the connecting arrangement 100 is now pushed onto the charging socket 200, the connecting arrangement 100 can comprise the base 220, for example, with the lateral surfaces 212 of the base, in particular with an inner side of the receiving opening 123, in particular indirectly via the seal 151. The recesses 204, 204′ consequently push into the connecting arrangement 100 and can be electrically contacted there with the connecting bolts 140, 140′. The overlap in the direction of insertion between the charging socket 200, in particular the base 220, and the connecting arrangement 100 reinforces the sealing effect against environmental influences of the contact surface.

FIG. 6 shows the charging socket 200 with a connecting arrangement 100 according to the invention arranged thereon.

In the embodiment shown, the assembly opening 122 is subdivided into two partial openings which each enable access to a connecting bolt 140 within the housing. A lateral surface 136 can comprise the assembly opening 124 and, for example, can be divided into regions as shown here. In the embodiment shown, two substantially round lateral surface parts 136 are arranged in the assembly opening 124. These can form access points to the connecting bolts 140, 140′ located therebelow (hidden in the housing). Lateral surfaces 136 are also enclosed by an outer lateral surface 136 enveloping the round lateral surfaces 136. Two locking elements 164, 164′ are arranged in the assembly opening. Among these, the connecting bolts 140, 140′ are located within the housing.

A safety device 138 is arranged in the assembly opening 122, in particular in a central region between the accesses to the connecting bolts, in particular in a region encompassed by the lateral surfaces 136. This safety device 138 can in particular be a HVIL safety device. The safety device 138 can be arranged on and/or in the housing 120.

The assembly opening 122 is surrounded by a seal 150.

FIG. 7 shows a charging socket 200 having a connecting arrangement 100 in an isometric representation. The charging socket 200 comprises at least two contact pins 202, 202′ in a first receptacle 210 of the charging socket 200 for a charging plug. The contact pins can in particular be electrically connected to the busbars 110, 110′, in particular via the connecting bolts 140, 140′. The charging socket 200 can comprise a charging socket housing 208.

1-38. (canceled)

39. A charging socket having a front side and a rear side facing away from the front side, comprising:
a first receptacle for a charging plug arranged on the front side,
a second receptacle for a connection assembly arranged on the rear side,
a plug-in peg arranged within the first receptacle and extending starting from the front side toward the rear side,
wherein the plug-in peg has a first region extending starting from a first end face to a central region and a second region extending starting from a second end face to the central region, wherein the first region extends starting from the rear side in the direction of the second receptacle and the second region extends into the first receptacle, wherein the plug-in peg has a recess on its first end face,
at least one connection assembly arranged on the second receptacle, with
a housing,
at least two busbars which are guided in each case with an end portion into the housing and are fixed relative to one another in the housing,
wherein a connecting bolt extending at an angle to the longitudinal axis of the busbar in an extension direction is arranged in an integrally bonded manner on a corresponding one of the busbars in the end portion,
wherein the connecting bolt tapers in the extension direction toward an end face of the connecting bolt facing away from the busbar and in particular has a through hole in the extension direction, and
wherein at least one receiving opening for the second receptacle is arranged in the housing and the connecting bolts are arranged in the receiving opening,
wherein at least one of the connecting bolts of the connecting arrangement is arranged in the recess in a form-fitting and/or frictionally engaged manner, in particular is screwed to the recess by means of a screw guided through the through-opening of the connection bolt.

40. The charging socket according to claim 39, wherein at least one separating element made of a non-conducting material is arranged in the housing and is arranged at least partially between the busbars, in particular in that the separating element is formed as a part of the housing, in particular in one piece with the housing.

41. The charging socket according to claim 39, wherein a peripheral seal is arranged on the receiving opening, in particular a seal made of silicone, rubber and/or plastics material, in particular in that the housing and the seal are jointly injection-molded and/or cast, in particular in a two-component injection molding process.

42. The charging socket according to claim 41, wherein the seal is arranged peripherally on the inner wall of the lateral surface of the receiving opening, wherein in particular the seal finishes substantially flush with the edge of the receiving opening and/or the seal has a greater length extent in the extension direction of the connecting bolt than the distance between the edge of the receiving opening and the seal.

43. The charging socket according to claim 41, wherein the seal has at least two, preferably three or more ribs.

44. The charging socket according to claim 39, wherein the housing has at least one bar opening for the at least two busbars, in particular at least one bar opening which is cross-sectionally adapted to the busbars jointly and/or a bar opening comprising a plurality of partial openings, wherein the partial openings are in particular in each case cross-sectionally adapted to one of the busbars.

45. The charging socket according to claim 44, wherein the housing comprises at least one housing part which preferably encloses at least one of the busbars, preferably in a cross-sectionally adapted manner, wherein the housing part comprises in particular two parts which jointly form at least one bar opening cross-sectionally adapted to at least one of the busbars.

46. The charging socket according to claim 45, wherein the housing part is connected to the housing in a frictionally engaged and/or form-fitting manner.

47. The charging socket according to claim 45, wherein the housing part and/or the housing has at least one busbar seal which is arranged at least partially between at least one of the busbars and the housing and/or
the housing part, in particular in a press fit, and/or the housing part and/or the housing has at least one housing part seal which is arranged at least partially between the housing and the housing part, in particular in a press fit.

48. The charging socket according to claim 47, wherein the busbar seal and the housing part seal are part of a one-piece seal and/or the housing part is formed as a seal.

49. The charging socket according claim 39, wherein at least one of the busbars and/or the at least two busbars are at least partially surrounded by an insulation, in particular in a region outside the housing and/or in at least a part of the end portion of at least one of the busbars.

50. The charging socket according to claim 39, wherein the housing comprises at least one assembly opening, in particular on the side of the connecting arrangement facing away from the receiving opening, wherein the assembly opening can in particular be closed with an assembly opening closure.

51. The charging socket according to claim 50, wherein the assembly opening closure is arranged on the housing in a captive manner, in particular by means of retaining means, in particular by means of hinges.

52. The charging socket according to claim 50, wherein the assembly opening has a peripheral lateral surface extending substantially in the extension direction of at least one of the connecting bolts.

53. The charging socket according to claim 39, wherein at least one of the busbars has at least one side recess, in particular a one-sided side recess, so that the busbar is asymmetrically shaped.

54. The charging socket according to claim 53, wherein at least one holding means for at least one of the busbars is provided, in particular in the housing, in particular a retaining means which engages in at least one side recess of at least one of the busbars, in particular a latching element, and/or
wherein at least one guide element is provided for at least one of the busbars, in particular a one-sided guide element, a two-sided guide element, a guide rail, a groove, and/or a click element, wherein in particular the wide side of at least one of the busbars pointing toward the receiving opening rests against the guide element.

55. The charging socket according to claim 39, wherein the connecting bolts of the at least two busbars protrude equally far out of the corresponding busbar in the extension direction of the corresponding connecting bolt, and/or
the connection bolts of the at least two busbars are substantially aligned perpendicular to the longitudinal axis and/or in parallel with the wide side of at least one of the busbars.

56. The charging socket according to claim 39, wherein the at least two busbars, in particular including their respective connecting bolts, are formed mirror-symmetrically to one another at least in part.

57. The charging socket according to claim 39, wherein at least one of the connecting bolts is conically tapered, in particular tapers in the shape of a truncated cone.

58. The charging socket according to claim 39, wherein the charging socket comprises a charging socket housing, and the housing and the charging socket housing are at least indirectly in contact with one another in a region peripherally surrounding the connecting bolts, in particular are in contact with one another by means of a seal, in particular peripherally, in particular in a gas-, liquid- and/or pressure-tight manner.

59. A system including a charging socket according to claim 39, wherein at least one of the connecting bolts of the connecting arrangement is arranged in a recess of the charging socket, in particular in a force-fitting and/or form-fitting manner, and the connection assembly is at least indirectly in contact with the charging socket peripherally around at least one of the connecting bolts.
